(19) United States
(12) Patent Application Publication
(10) Pub. No.: US 2015/0174777 A1
(43) Pub. Date: Jun. 25, 2015

(54) DOUBLE-EDGED KNIFE FOR FOOD CUTTING APPARATUS

(71) Applicant: Urschel Laboratories, Inc., Valparaiso, IN (US)

(72) Inventors: Michael Scot Jacko, Valparaiso, IN (US); Paul Bruce, Leicester (GB)

(21) Appl. No.: 14/565,011

(22) Filed: Dec. 9, 2014

Related U.S. Application Data
(60) Provisional application No. 61/914,031, filed on Dec. 10, 2013.

(51) Int. Cl. B26D 1/03; B26D 7/06; B26D 1/00

(52) U.S. Cl. CPC B26D 1/03; B26D 1/0006; B26D 7/0691; B26D 2001/004; B26D 2210/02

(57) ABSTRACT

Double-edged knives for use in centrifugal-type cutting apparatuses, for example, the Urschel Model CC®, and transverse cutting wheel-type cutting apparatuses, for example, the Urschel TranSlicer 2000®, to produce uniform cuts in bulk quantities of food products. Such a knife has a longitudinal length defining oppositely-disposed first and second ends and defining oppositely-disposed edges between the first and second ends. Each of the edges has a cutting edge defined thereon adapted for slicing food products. As a result, the knife has two operational life spans and can be removed and reinstalled to utilize either of its cutting edges.

### CROSS REFERENCE TO RELATED APPLICATIONS

This application claims the benefit of U.S. Provisional Application No. 61/914,031, filed Dec. 10, 2013, the contents of which are incorporated herein by reference.

### BACKGROUND OF THE INVENTION

The present invention generally relates to methods and equipment for cutting food products.

Various types of equipment are known for slicing, shredding and granulating food products, such as vegetable, fruit, dairy, and meat products. A widely used line of machines for this purpose is commercially available from Urschel Laboratories, Inc., under the name Urschel Model CC®, an embodiment of which is represented in FIG. 1. The Model CC® machine line provides versions of centrifugal-type slicers capable of producing uniform slices, strip cuts, shreds and granulations of a wide variety of food products at high production capacities.

FIGS. 2 and 3 are perspective views of an impeller 10 and cutting head 12, respectively, of types that can be used in the Model CC® machine. In operation, the impeller 10 is coaxially mounted within the cutting head 12, which is generally annular-shaped with cutting knives 14 mounted on its perimeter. The impeller 10 rotates within the cutting head 12, while the latter remains stationary. Each knife 14 projects radially inward toward the impeller 10 in a direction generally opposite the direction of rotation of the impeller 10, and defines a cutting edge at its radially innermost extremity. The impeller 10 has generally radially-oriented paddles 16 with faces that engage and direct food products (e.g., potatoes) radially outward against the knives 14 of the cutting head 12 as the impeller 10 rotates.

FIG. 1 schematically represents a Model CC® machine with the cutting head 12 mounted on a support ring 28 above a gear box 30. A housing 32 contains a shaft coupled to the gear box 30, through which the impeller 10 is driven within the cutting head 12. Further descriptions pertaining to the construction and operation of Model CC® machines are contained in U.S. Pat. Nos. 5,694,824 and 6,968,765, the entire contents of which are incorporated herein by reference.

The cutting head 12 shown in FIG. 3 comprises a lower support ring 18, an upper mounting ring 20, and circumferentially-spaced support segments (shoes) 22. The knives 14 of the cutting head 12 are individually secured with clamping assemblies 26 to the shoes 22, which are secured with bolts 25 to the support and mounting rings 18 and 20. The shoes 22 are equipped with coaxial pivot pins (not shown) that engage holes in the support and/or mounting rings 18 and 20. By pivoting on its pins, the orientation of a shoe 22 can be adjusted to alter the radial location of the cutting edge of its knife 14 with respect to the axis of the cutting head 12, thereby controlling the thickness of the sliced food product. As an example, adjustment can be achieved with an adjusting screw and/or pin 24 located circumferentially behind the pivot pins. FIG. 3 further shows optional gate insert strips 23 mounted to each shoe 22, which the food product crosses prior to encountering the knife 14 mounted to the succeeding shoe 22. The knives 14 are separate components of their respective clamping assemblies 26.

Another type of widely used line of machines commercially available from Urschel Laboratories, Inc., include versions of transverse rotating cutting wheel-type slicers capable of providing a wide variety of food products at high production capacities. Notable commercial embodiments of transverse rotating cutting equipment include the TranSlicer 2000® and the MicroSlice® wheel. FIG. 9 represents an exemplary embodiment of the MicroSlice® wheel having a cutting wheel 48 having a plurality of knives 54 attached thereto. The cutting wheel 48 comprises a hub 52 and a rim 50 to which the knives 54 are attached, for example with knife holders 56. In operation, the cutting wheel 48 rotates in the direction of arrow 66. A space 64 is formed between a second edge 58 of one knife holder 56 and a cutting edge 60 of an adjacent knife 54 such that the space 64 has a substantially constant circumferential dimension throughout its radial length. The constant dimensions of the spaces 64 enable a food product to be sliced with accuracy. Typically, the food product is transported through a cutting plane of the cutting wheel 48 at a constant speed and the cutting wheel 48 is rotated, also at a constant speed.

The knives 14 and 54 are constantly prone to deterioration and dulling due to their usage. Individual knives typically have a much shorter operational life span than the cutting head 12 and cutting wheel 48 and their other respective individual components. As such, knives are often replaced many times over the life span of a machine.

### BRIEF DESCRIPTION OF THE INVENTION

The present invention provides double-edged knives for use in centrifugal-type cutting apparatuses, for example, the Model CC®, and rotating cutting wheel-type cutting apparatuses, for example, the TranSlicer 2000®, to produce uniform cuts in bulk quantities of food products.

According to an aspect of the invention, a knife adapted for producing sliced food products has a longitudinal length defining oppositely-disposed first and second ends and defining oppositely-disposed edges between the first and second ends. Each of the edges has a cutting edge defined thereon adapted for slicing food products.

According to another aspect of the invention, a shoe assembly of a centrifugal-type slicing machine adapted for producing sliced food products includes a shoe, a knife holder mounted to the shoe, a knife mounted to the knife holder, and means for clamping the knife to the knife holder. The knife has a longitudinal length defining oppositely-disposed first and second ends and defining oppositely-disposed edges between the first and second ends, and each of the edges has a cutting edge defined thereon adapted for slicing food products.

A technical effect of the invention is that, due to the knife having two cutting edges, the knife has two operational life spans and can be removed and reinstalled to utilize either of its cutting edges, often enabling the knife to be replaced half as often as a conventional blade.

Other aspects and advantages of this invention will be better appreciated from the following detailed description.

### BRIEF DESCRIPTION OF THE DRAWINGS

FIG. 1 is a side view representing a centrifugal-type cutting apparatus known in the art.

FIGS. 2 and 3 are perspective views representing, respectively, an impeller and a cutting head suitable for use in the cutting apparatus represented in FIG. 1.

FIG. 4 is a perspective view of a shoe assembly equipped with a double-edged knife in accordance with an aspect of the present invention.

FIGS. 5 and 6 are perspective views of double-edged bevel-cut knives in accordance two embodiments of the present invention, wherein the knife of FIG. 5 has a handle and the knife of FIG. 6 does not.

FIG. 7 is an end view of the double-edged bevel-cut knife of FIG. 5.

FIG. 8 is an end view of a double-edge knife similar to FIGS. 5 and 7, but modified to have bias-cut edges.

FIG. 9 is a front view representing a cutting wheel known in the art.

FIGS. 10 and 11 are perspective views of knife holders equipped with a double-edged knife in accordance with an aspect of the present invention.

FIG. 12 is a side view of a knife holder equipped with a double-edged knife in accordance with an aspect of the present invention.

### DETAILED DESCRIPTION OF THE INVENTION

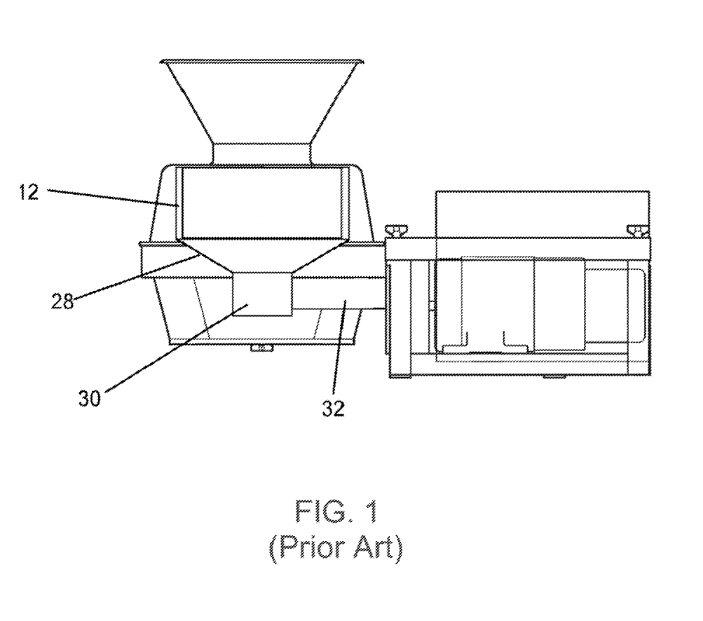

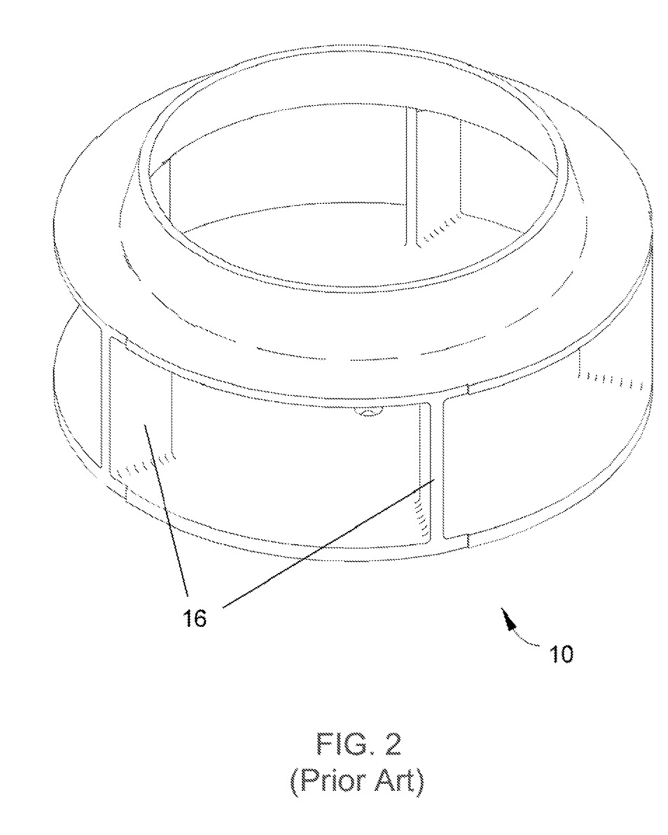

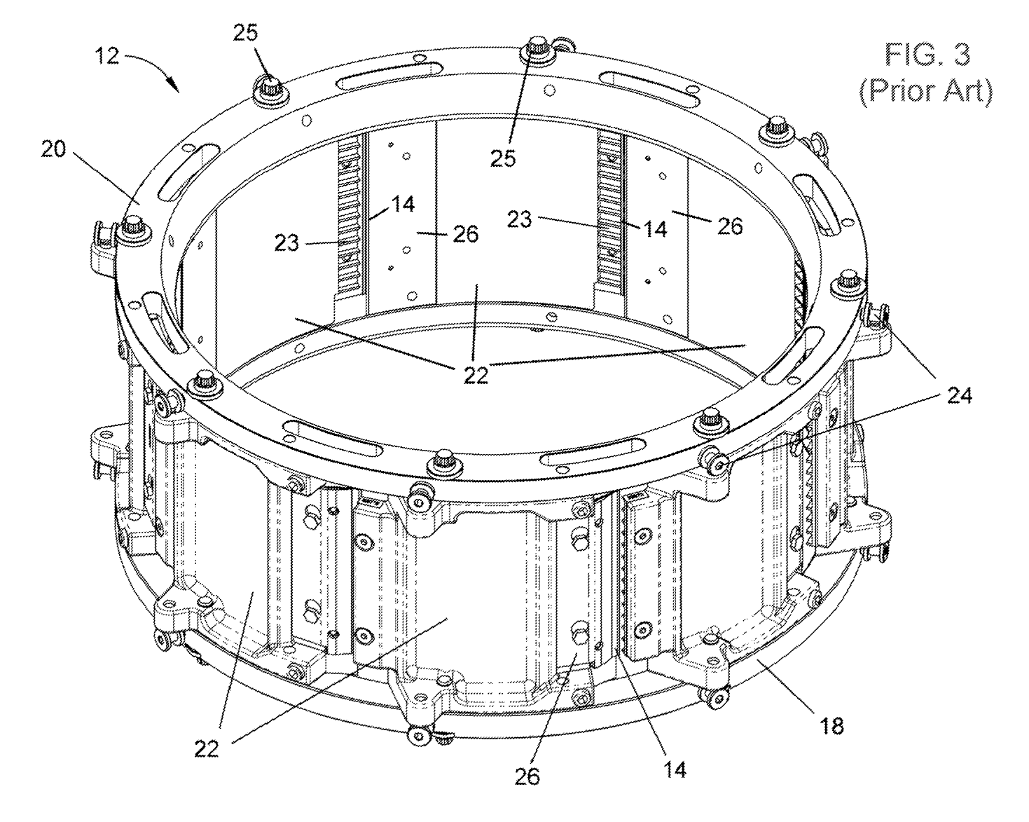

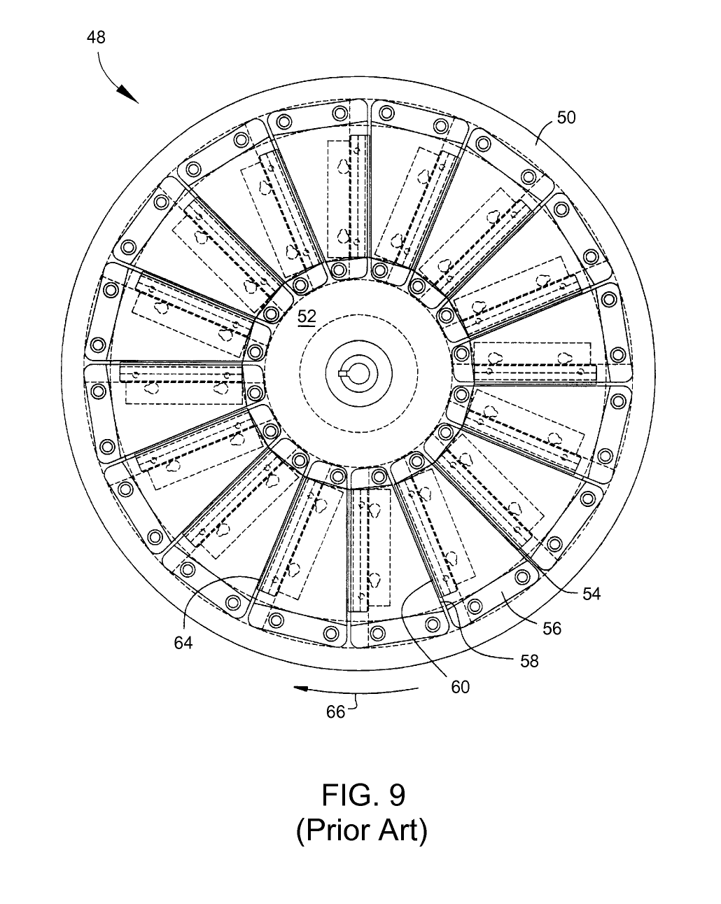

The present invention provides knives for making slice cuts in food products. Such knives can be utilized in centrifugal-type slicers, nonlimiting examples of which are the Urschel Model CC® machines and the Urschel TranSlicer 2000®, which are capable of producing uniform slices, strip cuts, shreds and granulations of a wide variety of food products at high production capacities. For convenience, the invention will be described in reference to the machine and components represented in FIGS. 1-3 and the cutting wheel 48 represented in FIG. 9, and particularly the cutting head 12 represented in FIG. 3, though it should be understood that the invention is not so limited.

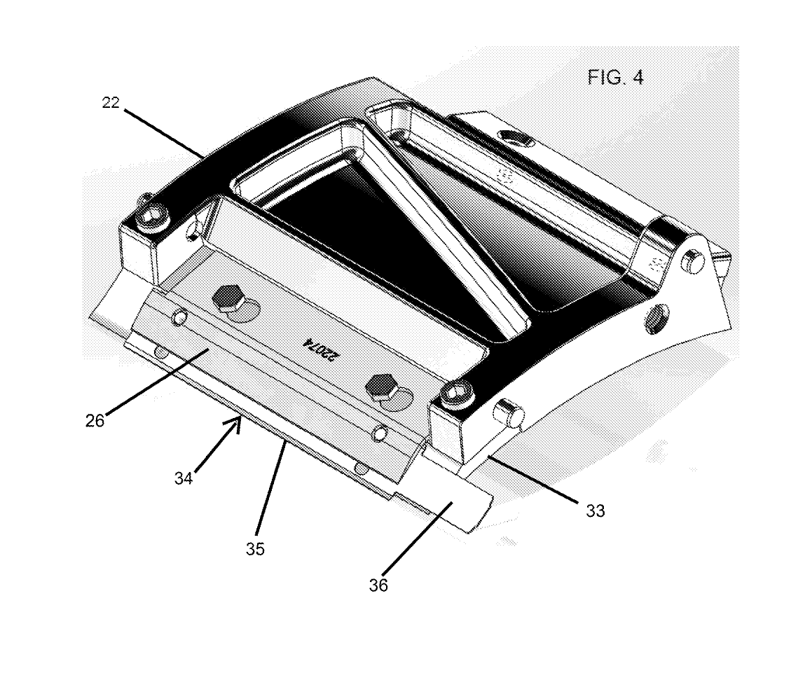

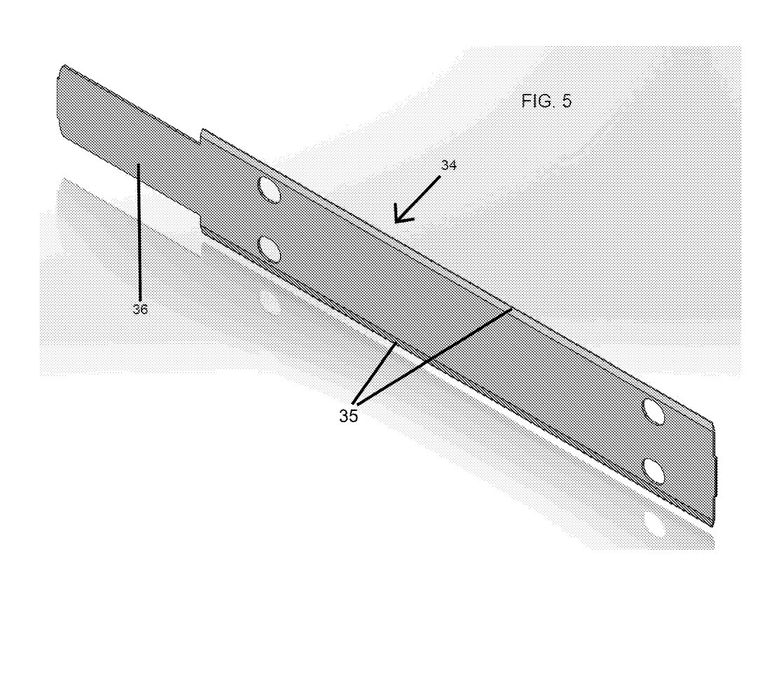

FIG. 4 illustrates a shoe 22 adapted for use in the cutting head 12 of FIG. 3, but modified to make use of a double-edged knife 34 represented in FIG. 5. The shoe 22 is represented as being assembled with a knife holder 33, to which a knife 34 is mounted and securing with a clamping assembly 26. Additional details and aspects of the shoe 22 can be obtained from the description relating to FIG. 3, and therefore will not be repeated here.

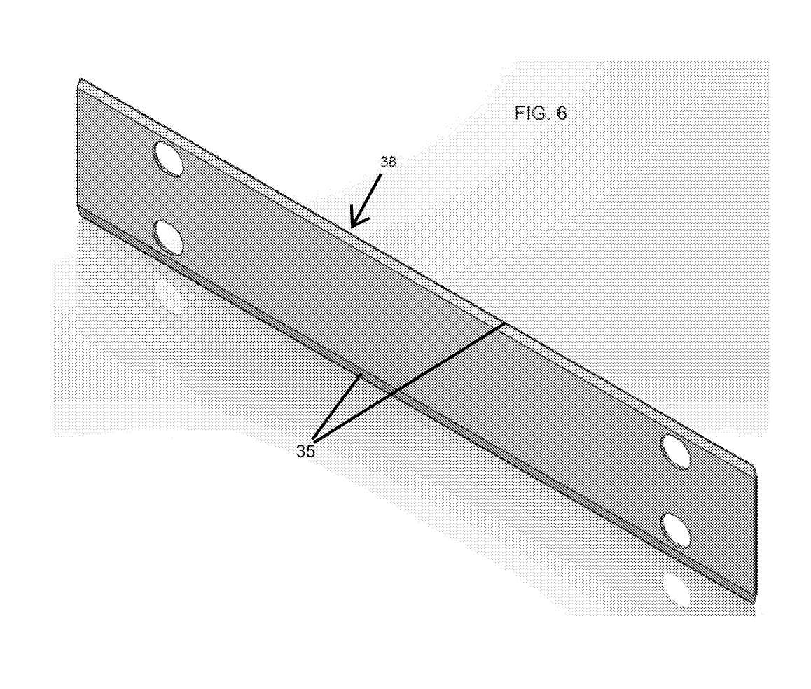

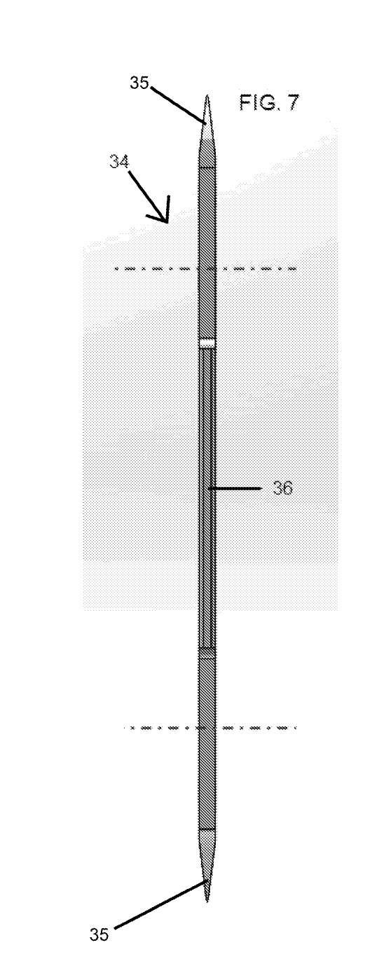

The knife 34 represented in FIG. 4 is shown in isolation in FIG. 5. The knife 34 is represented as having a longitudinal length defining oppositely-disposed ends and oppositely-disposed edges 35 between the ends. A cutting edge is defined at each edge 35 for slicing food products. The cutting edges 35 are bevel-cut (substantially centered apex), as can be better appreciated from the end view of FIG. 7. The bevel-cut edges 35 result in the knife 34 having a symmetrical configuration. The knife 34 of FIG. 5 is further represented as being fabricated to include a handle 36 that extends from one of the longitudinal ends of the knife 34. The handle 36 is adapted to facilitate removal from and reinstallation of the knife 34 in the shoe assembly 22. For this reason, the cutting edges 35 do not extend over the handle 36, which is narrower in width than the portion of the knife 34 on which the cutting edges 35 are formed. FIG. 6 represents another possible embodiment of the invention, in which a double-edged bevel-cut knife 38 is configured similar to the knife 34 of FIG. 5, but lacks the handle 38 of the knife 34, such that the cutting edges may extend the full length of the knife 38.

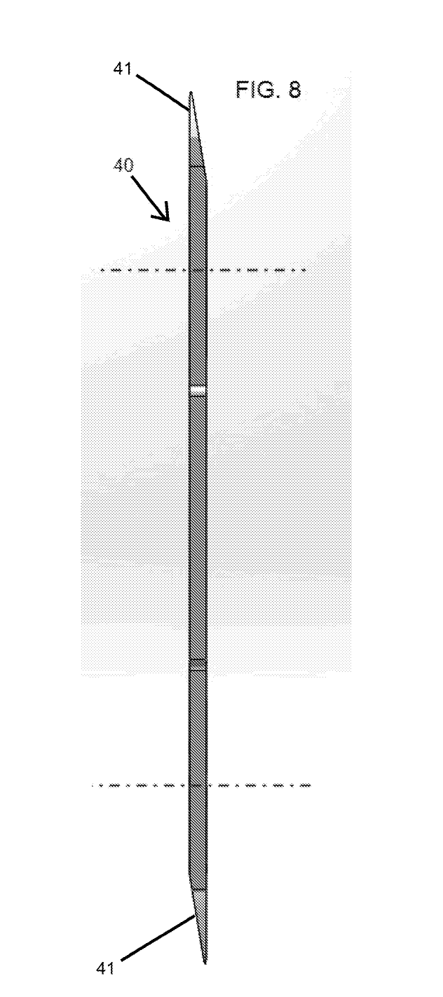

FIG. 8 illustrates an end view of a double-edged knife 40 similar to the knife 38 of FIG. 6, but with cutting edges 41 that define a bias cut. The bias cut is distinct from the bevel cut represented in FIGS. 5-7, in that one side of each knife edge is predominantly machined with the result that the knife 40 is not symmetrical. Whether a knife having bevel-cut edges 35 or bias-cut edges 41 is preferred will depend on the intended use of the knife. Processes for producing the bevel-cut and bias-cut edges 35 and 41 are well known and will not be described here.

In addition, the knives discussed above may have additional features to accommodate the shoe 22 and clamping assembly 26 in which it is to be installed. Any configurations of grooves, notches, holes, or other features which allow the knife to be installed and locked into place in the shoe 22 (or another suitable shoe assembly) are specific to the design of the shoe, and are not limiting aspects of this invention. Preferably, the clamping assembly 26 may be configured to accommodate the knife 34, 38, or 40 such that a first edge 35 or 41 not being used is not in contact with surfaces of the clamping assembly 26 while the knife 34, 38, or 40, is secured by the clamping assembly 26, thereby reducing the likelihood of damage to the first edge 35 or 41 while a second edge 35 or 41 of the knife 34, 38, or 40 is being used to slice food product.

An advantage of the knives 34, 38, and 40 as described above is that when one edge 35 or 41 becomes dull during operation of the cutting machine, the knife 34, 38, or 40 can be removed from the shoe assembly 22, turned over, and reinstalled so that the unused edge 35 or 41 serves as the cutting edge of the knife 34, 38, or 40, whereas the worn edge 35 or 41 is preferably secured and concealed between the shoe 22 and clamping assembly 26.

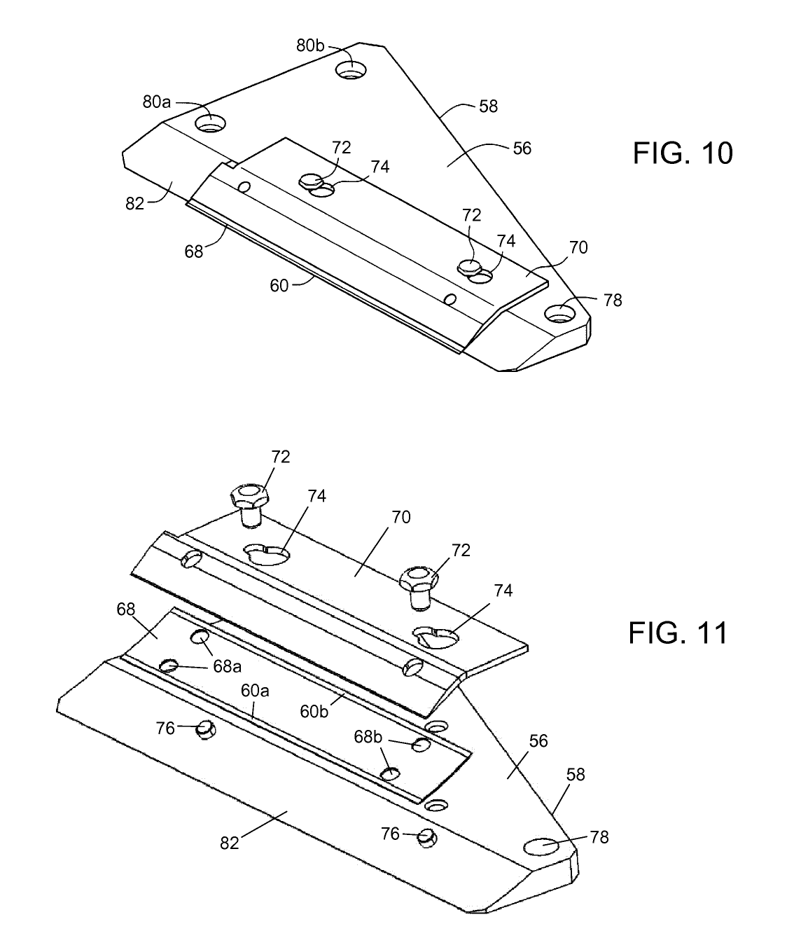

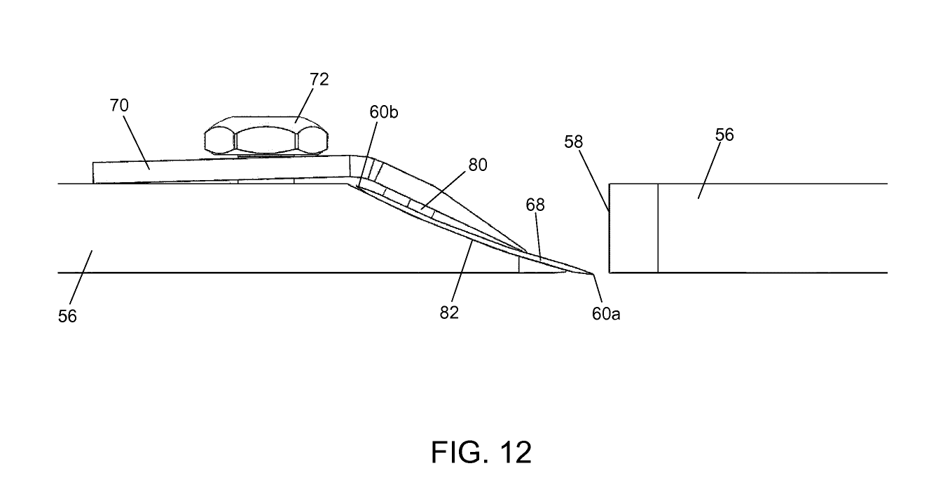

FIGS. 10 through 12 represent the knife holder 56 suitable for use with the cutting wheel 48 represented in FIG. 9. The knife holder 56 comprises a double-edged knife 68 mounted thereon. The knife 68 has a longitudinal length defining oppositely disposed ends and oppositely disposed edges 60a and 60b between the ends. A cutting edge is defined at each edge 60a and 60b for slicing food products. The knife 68 may be permanently attached to the knife holder, or may be removably held by a clamp 70. Knife 68 is held against surface 82 formed on the knife holder 56 by clamp 70, which is attached to the knife holder 56 by fasteners 72. Clamp 70 may engage the fasteners 72 by way of keyhole-shaped slots 74 which enable the removal of the clamp 70 by merely loosening the fasteners 72 and moving the clamp 70 such that the heads of the fasteners 72 are aligned with the larger opening portion of the keyhole shaped slots 74 and then removing the clamp 70. Locating studs 76 extend from the knife holder 56 and engage openings 68a and 68b in the knife 68 to properly locate the knife 68 on the knife holder 56. Knife holder 56 has second edge 58 formed thereon and, as can be seen, the second edge 58 extends obliquely with respect to the cutting edge 60 of the knife 68. Knife holder 56 has hub mounting hole 78 and rim mounting holes 80a and 80b formed therein for attachment to the hub 52 and rim 50, respectively, of the cutting wheel 48. FIG. 12 represents a side view of the knife 68 secured in the knife holder 56 with the clamp 70. Similar to the knives 34, 38, and 40, the knife 68 may have bevel-cut edges or bias-cut edges, may optionally include a handle (not shown), and has the advantage of having the ability to be turned over to effectively double the life of the knife 68. The knife holder 56 may further include means for biasing at least a portion of the knife 68 towards the surface 82 such that the cutting edge 60b is not in direct contact with the knife holder 56 while the knife 68 is secured to the knife holder 56. For example, FIG. 12 represents the clamp 70 as securing the knife 68 such that the body of the knife 68 is forced along the surface 82.

While the invention has been described in terms of specific embodiments, it is apparent that other forms could be adopted by one skilled in the art. For example, the knife assemblies and the apparatus in which they are installed could differ in appearance and construction from the knife assemblies and cutting heads shown in the drawings, and materials and processes other than those noted could be used. Therefore, the scope of the invention is to be limited only by the following claims.

1. A knife adapted for producing sliced food products, the knife comprising a longitudinal length defining oppositely-disposed first and second ends and defining oppositely-disposed edges between the first and second ends, each of the edges having a cutting edge defined thereon adapted for slicing food products.

2. The knife of claim 1, wherein the knife further comprises a handle disposed at the first end thereof, the cutting edges of the knife being present between the handle and the second end but not being present on the handle.

3. The knife of claim 1, wherein the cutting edges are bias-cut edges.

4. The knife of claim 1, wherein the cutting edges are substantially centered bevel-cut edges.

5. The knife of claim 1, wherein the knife is configured to be installed on a centrifugal-type slicing machine.

6. The knife of claim 1, wherein the knife is configured to be installed on a rotating cutting wheel-type slicing machine.

7. A shoe assembly of a centrifugal-type slicing machine adapted for producing sliced food products, the shoe assembly comprising:
a shoe;
a knife holder mounted to the shoe;
a knife mounted to the knife holder; and
means for clamping the knife to the knife holder;
wherein the knife comprises a longitudinal length defining oppositely-disposed first and second ends and defining oppositely-disposed edges between the first and second ends, and each of the edges has a cutting edge defined thereon adapted for slicing food products.

8. The shoe assembly of claim 7, wherein the knife further comprises a handle disposed at the first end thereof, the cutting edges of the knife are present between the handle and the second end but are not present on the handle, and the handle protrudes from an edge of the shoe.

9. The shoe assembly of claim 7, wherein the cutting edges are bias-cut edges.

10. The shoe assembly of claim 7, wherein the cutting edges are substantially centered bevel-cut edges.

11. The shoe assembly of claim 7, wherein the shoe assembly is installed on a centrifugal-type slicing machine.

12. The centrifugal-type slicing machine of claim 11.

13. A knife holder of a rotating cutting wheel-type slicing machine adapted for producing sliced food products, the knife holder comprising:
a knife holder configured for mounting to a cutting wheel;
a knife mounted to the knife holder; and
means for clamping the knife to the knife holder;
wherein the knife comprises a longitudinal length defining oppositely-disposed first and second ends and defining oppositely-disposed edges between the first and second ends, and each of the edges has a cutting edge defined thereon adapted for slicing food products.

14. The knife holder of claim 13, wherein the cutting edges are bias-cut edges.

15. The knife holder of claim 13, wherein the cutting edges are bevel-cut edges.

16. The knife holder of claim 13, wherein the knife holder is installed on a rotating cutting wheel-type slicing machine.

17. The rotating cutting wheel-type slicing machine of claim 16.
